(19) United States
(12) Patent Application Publication
(10) Pub. No.: US 2023/0158481 A1
(43) Pub. Date: May 25, 2023

(54) METHOD FOR PREPARING A DEGRADATIVE SOL, A DEGRADATIVE SOL, A DEGRADATIVE SURFACE, A METHOD FOR PROVIDING A DEGRADATIVE SURFACE AND A METHOD FOR DEGRADING ORGANIC SUBSTANCES

(71) Applicant: Plasmonics Oy, Tampere (FI)

(72) Inventors: Mika VALDEN, Suinula (FI); Bela BHUSKUTE, Tampere (FI)

(21) Appl. No.: 17/532,113

(22) Filed: Nov. 22, 2021

(51) Int. Cl. B01J 35/00; B01J 37/34; B01J 37/02; B01J 21/06; B01J 23/52; B01J 23/50; B01J 35/02

(52) U.S. Cl. CPC B01J 35/0013; B01J 35/004; B01J 37/345; B01J 37/0221; B01J 21/063; B01J 23/52; B01J 23/50; B01J 35/023; B01J 35/026

(57) ABSTRACT

The present disclosure provides a method for preparing a degradative sol, the method comprising providing an aqueous dispersion of titanium dioxide nanoparticles, providing gold and/or silver precursor compound(s) to the dispersion, illuminating the dispersion with ultraviolet light to photodeposit gold and/or silver nanoparticles onto the titanium dioxide nanoparticles to obtain photocatalytic plasmonic nanoparticles having a plasmonic resonance frequency in visible spectrum of electromagnetic radiation, and providing the photocatalytic plasmonic nanoparticles as a degradative sol. The present disclosure also provides a degradative sol, a degradative surface, a method for providing a degradative surface and a method for degrading organic substances.

### FIELD OF THE APPLICATION

The present disclosure relates to degradative nanoparticles, degradative sols comprising the nanoparticles and methods for preparing the sols. The present disclosure also relates to methods for providing catalytically active degradative surface and for degrading organic substances.

### BACKGROUND

Photocatalysis refers to acceleration of a chemical reaction in the presence of photocatalysts, which can absorb light quanta of appropriate wavelengths depending on the band structure. Usually, semiconductors having a relatively narrow band gap and distinct electronic structure, such as TiO₂, Fe₂O₃, WO₃, ZnO, CeO₂, CdS, Fe₂O₃, ZnS, MoO₃, ZrO₂, and SnO₂, are used as photocatalysts.

The photocatalysis is utilized for degrading organic compounds on substrates under sunlight or artificial light and presence of oxygen and/or water. This degradative reaction can also be used against microbes and biofilms.

It is often desired to obtain a coating on surfaces, such as at public places and other places, and especially on surfaces which are frequently contacted by people. Such need has recently emerged for example due to the Covid 19 pandemic, and it is desired to obtain surfaces which can be catalytically sterilized to neutralize microbes, such as viruses and bacteria. However, photocatalytically active coatings usually require ultraviolet light, such as sunlight, and/or strong light, which require use of specific light sources, which are not applicable at all location, such as public places. Therefore, the existing photocatalytic coatings perform poorly or are not suitable at locations with weak light, such as indoors. It is desired to obtain durable high quality dry coatings on surfaces, having an even distribution of the active agents in active and stable form, especially capable of providing catalytic activity in presence of a variety of light types or sources, preferably even at low light exposure.

Further, there are other challenges in the whole chain of obtaining such catalytic coatings beginning from the manufacture of suitable catalytic materials, coating materials comprising the catalytic materials, storing, transporting and using said materials, to finally obtaining desired coating with desired properties and utilizing the coatings. For example, it is challenging to obtain coating compositions with efficient active agents, especially in such form which is safe and tolerates storing, transporting, handling, application and other required actions. Especially nanosized catalytic materials tend to aggregate in dispersions, which shortens the shelf-life and makes such material challenging or even impossible to apply, for example by spraying. To achieve all these goals is a complex task which has provided several challenges so far.

There is a need for methods for producing efficient and inexpensive catalytic materials and coating compositions, especially simple and economic methods, which provide catalytic materials and coating compositions in durable form which also tolerates the operations discussed in previous.

There is also a need for efficient catalytic materials which can be used in a variety of targets and conditions, especially to neutralize harmful substances and biological material, such as viruses and bacteria. There is also a need for coating compositions suitable for treating such variety of targets and surfaces and to obtain coatings that are active and stable in a variety to conditions against a variety of harmful substances. For example, coatings that are exposed to ambient conditions including direct sunlight, humidity and/or dry conditions, wear, pollutants, solvents, detergents, oxidants etc. should especially exhibit durability and stability, and maintain the catalytic properties. On the other hand, there is also a need for coating compositions that are useful indoors and at regular artificial light.

### SUMMARY

In the present case it was found out how to obtain catalytically active materials and compositions, which could be used to overcome drawbacks of the prior art. Especially it was desired to obtain stabile degradative catalytic coatings for coating a variety of surfaces and which coatings could exhibit the catalytic activity at low and/or visible light, and at ambient conditions. The catalytic materials utilize surface plasmon resonance to enhance the catalytic activity of the used materials.

The present disclosure provides catalytic materials and compositions and degradative surface comprising, such as coated with, plasmonic nanoparticles which can couple with electromagnetic radiation of wavelengths that are larger than the particle due to the nature of the dielectric-metal interfaces. This enables usage of low energy photons in generating conditions for photocatalysis. The advantage of this arrangement is that visible light, for example ambient indoor lighting can be effectively used.

Disclosed are plasmonic composite nanoparticles and a degradative surface comprising the plasmonic composite nanoparticles of a metallic material such as gold or silver or a mixture thereof, and titanium dioxide as a semiconducting material, which have plasmonic resonance frequencies in the range of visible light wavelengths.

The present disclosure provides a method for preparing a degradative sol, the method comprising
providing an aqueous dispersion of titanium dioxide nanoparticles,
providing gold and/or silver precursor compound(s) to the dispersion,
illuminating the dispersion with ultraviolet light to photodeposit gold and/or silver nanoparticles onto the titanium dioxide nanoparticles to obtain photocatalytic plasmonic nanoparticles having a plasmonic resonance frequency in visible spectrum of electromagnetic radiation, and
providing the photocatalytic plasmonic nanoparticles as a degradative sol, preferably forming the photocatalytic plasmonic nanoparticles into a degradative sol.

The present disclosure provides a degradative sol comprising an aqueous dispersion of photocatalytic plasmonic nanoparticles having a plasmonic resonance frequency in visible spectrum of electromagnetic radiation and comprising gold and/or silver nanoparticles deposited on titanium dioxide nanoparticles. The photocatalytic plasmonic nanoparticles and/or the sol can be obtained with the photodeposition methods disclosed herein.

The present disclosure provides a degradative surface coated with photocatalytic plasmonic nanoparticles having a plasmonic resonance frequency in visible spectrum of electromagnetic radiation and comprising gold and/or silver nanoparticles deposited on titanium dioxide nanoparticles.

The present disclosure provides a method for providing a degradative surface, such as an antibacterial surface, the method comprising
providing the degradative sol,
coating a surface with the degradative sol, to obtain a catalytically active degradative surface coated with photocatalytic plasmonic nanoparticles having a resonance frequency in visible spectrum of electromagnetic radiation and comprising gold and/or silver nanoparticles deposited on titanium dioxide nanoparticles, such as photocatalytically active degradative surface.

The present disclosure provides a method for degrading organic substances, such as eliminating microbes, the method comprising
providing the degradative surface,
allowing the photocatalytic plasmonic nanoparticles to catalytically degrade organic substances on the surface, optionally in the absence of light, in the absence of oxygen and/or in the presence of light and/or oxygen.

The main embodiments are characterized in the independent claims. Various embodiments are disclosed in the dependent claims. The embodiments and examples disclosed herein are mutually freely combinable unless otherwise explicitly stated.

It was found out that light harvesting capacity of TiO₂ is significantly extended in visible region by vicinity of gold and/or silver metals due to its surface plasmonic resonance property. Especially the photodeposition of gold after silver on TiO₂ resulted in significant improvement in the photocatalytic efficiency compared to gold alone. In contrast, photodeposition of silver before gold results in lower performance compared to gold alone. The obtained materials were found to provide efficient photocatalytic activity already at low light and at a visible spectrum area, such as at indoor light, for example by using consumer light such as LED or the like. No dedicated lightning was required, which are usually strong and/or utilize undesired wavelengths, but the coatings could exhibit their activity already at existing light conditions, such as at regular indoor lightning. On the other hand, it is also possible to select specific lightning, for example by using LEDs, which are able to provide monochromatic light at a specific wavelength, so the lightning can be selected according to the photocatalytic material to optimize the photocatalytic activity. It was also found out that it was possible to adjust and optimize the photocatalytic material according to the used light by selecting a suitable composition of the bimetallic gold and silver having a maximum in the used light area. This enables providing photocatalytic coatings tailored to a specific target or conditions, for example according to the lightning at the target.

The photocatalytic coatings exhibit degradative action towards organic substances, including microbes such as bacteria, viruses, fungi, algae, even plants and the like, both unicellular and multicellular organisms, but also other organic or inorganic substances, such as volatile organic compounds (VOC), pollutants, debris or other contaminants or undesired substances. The coating is efficiently activated by light and airborne water vapor, wherein the activated coating forms reactive oxygen species. These species are very short-lived, as they react with microbes and organic compounds on the surface. The microbes and organic compounds decompose while reactive oxygen species are converted to water and carbon dioxide.

It was also found out that it is possible to produce photocatalytic coatings in a form of a sol in a simple and unexpensive process. The sol could be obtained directly from the process of preparing catalytic particles, and the sol was already in a form that could be used for coating, or the sol could be easily further processed to obtain more specific coating materials.

It was possible to obtain a sol product wherein the photocatalytic particles remain as highly dispersed particles, so the aggregation of the nanoparticles during storage can be avoided. This enables not only a prolonged shelf-life but also using a variety of application methods, such as spraying, to obtain a fine spray and homogenous distribution of the catalytic particles on a surface. This further facilitates fully obtaining efficient catalytic properties at the target. On the other hand, it is possible to use less coating dispersion, or catalytic material, to treat a surface compared to prior art coating compositions.

The obtained catalytic coatings are stable and maintain their catalytic properties. The coatings remain at different surfaces and are not damaged or released easily.

### BRIEF DESCRIPTION OF THE FIGURES

FIG. 1 shows a flowchart of an example of the method

FIG. 2 shows a flowchart of another example of the method

FIG. 3 shows UV/Visible absorption spectra of (a) TiO₂ (P25) (b) Ag/TiO₂ (c) Au/TiO₂ and (d) Ag—Au/TiO₂

FIG. 4 shows photocatalytic activity measurements of methylene blue degradation due to presence of catalyst nanoparticles under solar irradiation

### DETAILED DESCRIPTION

In this specification, percentage values, unless specifically indicated otherwise, are based on weight (w/w). If any numerical ranges are provided, the ranges include also the upper and lower values. The open term “comprise” also includes a closed term “consisting of” as one option. The diameters disclosed herein, unless specifically indicated otherwise, refer to the smallest diameter, and may be presented as average diameter, which may be number-average diameter, and may be determined microscopically, with energy dispersive X-ray spectroscopy or with any other applicable method.

In the present invention it was found out that titanium dioxide (TiO₂) is an excellent choice for a basis for catalytic materials to be used for coating a variety of targets. It was further found out that when the photocatalysis was obtained by using surface plasmon resonance based on titanium nanoparticles as semiconducting material deposited with gold and/or silver, it was possible to obtain effective photocatalytic coatings, which maintained the activity at the target, and provided activity already at a visible light spectrum and at a low level of the light. This however required specific preparation methods utilizing photodeposition.

TiO₂ is a commonly used photocatalyst due to its availability, effectiveness, and low cost. Titanium dioxide TiO₂ can be used for a wide range of applications because of its non-toxicity, abundance (inexpensiveness), thermal/chemical stability, and high redox potential. Anatase (tetragonal), rutile (tetragonal), and brookite (orthorhombic) are three polymorphs of TiO₂.

TiO₂ can absorb electromagnetic radiation in the ultraviolet (UV) range, causing the photoexcitation of electrons in its valence band to be promoted to its conduction band, creating an electron-hole pair. This electron-hole pair can then undergo further reactions with dissolved oxygen and water to form reactive radical species. Generation of superoxide anions at the cathodic sites and of hydroxyl radicals at the anodic sites of the photocatalyst can lead to the production of other reactive species such as hydrogen peroxide.

One disadvantage of TiO₂ as a photocatalyst is its large bandgap. Band gaps of anatase, rutile and brookite phases are 3.2, 3.0 and 3.4 eV respectively. Using TiO₂ as a photocatalyst requires ultraviolet light. TiO₂ can only adsorb about 5% of the solar spectrum and less than 1% of the typical commercial ambient LED light.

During the photocatalytic process, free electrons/holes, and reactive oxygen species (ROS), also called as reactive oxidizing species or reactive species, such as HO2., HO. and O2.- react with the surface adsorbed impurities including inorganic and organic compounds, and biological species such as bacteria, virus, etc. leading for example to their decomposition, inactivation and cell death through reaction with functional components in the microbial cell envelope. The efficiency of a photocatalytic reaction mainly depends on the capability of the photocatalyst to generate longer-lived electrons and holes that result in formation of reactive free radicals. Usually, the crucial aspect is the creation and efficient utilization of the reactive oxygen species.

The issues can be partly overcome by modifying TiO₂ by introducing Ag deposits, which alter the structure and mode of photocatalytic action because silver can act as electron traps which enhance electron—hole separation. The electrons can then be transferred to molecular oxygen to form superoxide and subsequently, other ROS.

In the present invention it was found out how to utilize surface plasmon resonance to obtain catalytic materials with new properties. It is possible to use such material to provide photocatalytic or other catalytic properties at different targets and at different conditions. For example, it is possible to obtain materials which are effective at low light and/or at visible light, and even materials which can be tailored according to a specific light. The present materials include TiO₂ as a semiconducting material and gold and/or silver as a first and optionally as a second metallic material(s) deposited on the TiO₂. It is desired to utilize visible light for photoactivating the material. The visible light refers to the visible spectrum of electromagnetic radiation and may correspond to a wavelength area in the range of 380-790 nm, such as 400-760 nm. It may be desired to use primarily a wavelength in the range of 540-760 nm. It is preferred to avoid utilizing ultraviolet range, which may refer to wavelengths below 400 nm or below 380 nm, which may be harmful to human, especially in applications utilizing artificial light and/or indoor applications. It is also preferred to use light sources which are controllable, such as artificial light sources, such as electric light sources.

Surface plasmon resonance is a phenomenon arising from the collective oscillation of conduction electrons of nanoscale noble metals upon interacting with electromagnetic radiation. The shape, amplitude, and frequency of the maximum absorbance of this SPR is strongly dependent on the effective dielectric constant in the surrounding medium of the nanoparticles, and the irrespective morphologies and size distributions. SPR can dramatically amplify visible light absorption for the present catalysts. In the SPR-enhanced materials, surface electrons can be excited, and interfacial electron transfer can occur.

Different methods may be applied to deposit plasmonic metal nanoparticles on semiconductor surface, including electrodeposition, atomic layer deposition, sputtering, flame spray pyrolysis, deposition precipitation, impregnation, physical mixture, coprecipitation and photodeposition. However, compared to other methods, for the present purposes photodeposition was found especially suitable since it does not require elevated temperatures or electricity, it is suitable for the particulate photocatalysts and, most importantly, the growth process is directed by the photo-induced reduction of metal ions from the solution phase to the semiconductor particle surface. Photodeposition can be used to control the properties of the obtained nanoparticles, such as geometrical distribution, size and density. For example, features such as pH, selection of precursors and concentrations thereof, presence of other substances, deposition time and illumination efficiency have an impact to the process and to the obtained product. Using more than one material to be deposited makes the process more complicated and the deposition order was found to have a significant impact to the properties of the obtained products, such as to nanoparticle morphology. Especially photodeposition enabled preparing the present bimetallic nanoparticles in the presence of titanium dioxide nanoparticles.

Plasmonic nanoparticles of different metals can be grown sequentially by photodeposition, but a different growth process has been expected if the semiconductor already has plasmonic nanoparticles. The present methods do not include doping, and the obtained nanoparticles are not doped nanoparticles.

For the desired uses the photocatalytic materials can be provided in the form of an aqueous sol. A sol is a colloid comprising or consisting of solid particles in a continuous liquid medium.

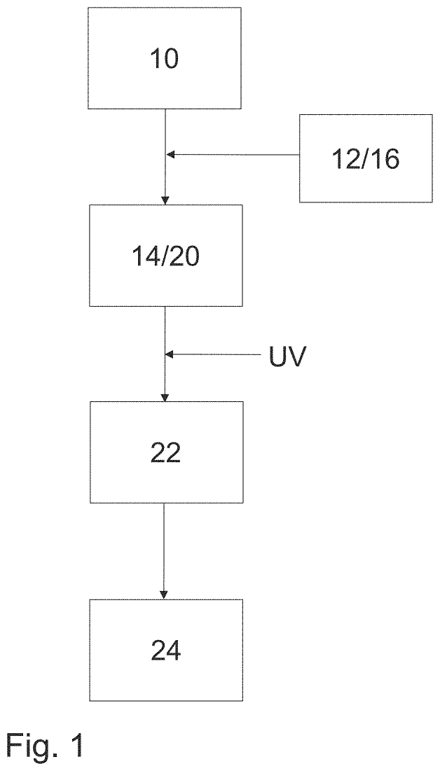

The present disclosure as disclosed in FIG. 1 provides a method for preparing a degradative sol, preferably a sprayable sol, the method comprising
providing a dispersion of titanium dioxide nanoparticles 10,
providing gold 12 and/or silver 16 precursor compound(s) to the dispersion to obtain a dispersion 14, 20 comprising titanium dioxide nanoparticles and gold 12 and/or silver 16 precursor compound(s),
illuminating the obtained dispersion 14, 20 with ultraviolet light (UV) to photodeposit gold and/or silver nanoparticles onto the titanium dioxide nanoparticles to obtain photocatalytic plasmonic nanoparticles having a resonance frequency in visible spectrum of electromagnetic radiation and comprising gold and/or silver nanoparticles deposited on the titanium dioxide nanoparticles 22, and
providing the photocatalytic plasmonic nanoparticles as a degradative sol 24, preferably forming the photocatalytic plasmonic nanoparticles into a degradative sol 24. The photocatalytic plasmonic nanoparticles having a resonance frequency in visible spectrum of electromagnetic radiation and comprising gold and/or silver nanoparticles deposited on the titanium dioxide nanoparticles 22 may be obtained already in the form of the degradative sol 24, or one or more further process steps may be carried out to form the photocatalytic plasmonic nanoparticles 22 into the degradative sol 24. The sol may be provided as packed in a suitable packing, container, bag or the like.

The obtained photocatalytic plasmonic nanoparticles may comprise or consist of gold and/or silver nanoparticles deposited on, or immobilized, included or incorporated in or on the titanium dioxide nanoparticles, or titanium dioxide nanoparticles deposited with gold and/or silver nanoparticles.

The degradative sol may be an antimicrobial sol. “Antimicrobial” as used herein refers to any microbes, such as unicellular and multicellular, including bacteria, viruses and the like as discussed herein. However, the present materials may also degrade other organic substances, such as discussed herein, and/or inorganic substances. “Degradative” as used herein refers to catalytically degradative, catalytically active or activatable, such as photocatalytically degradative, active or activatable, materials which can provide the desired ability to degrade substances when active or activated. The degradative materials and surfaces can produce reactive oxygen species, as discussed herein. For example, the photocatalytic materials may be activatable by light, such as any light and/or light source disclosed herein, for example artificial light, consumer light, ambient light, regular indoor light, and/or sources thereof, preferably light or light source emitting light only or mainly at the visible wavelength range.

Titanium dioxide nanoparticles may be provided in a suitable form having a suitable particle size and distribution. The TiO₂ nanoparticles may have a suitable specific surface area (BET), such as in the range of 35-65 m²/g. The average diameter or average particle size of the titanium dioxide nanoparticles may be in the range of 10-50 nm, such as 10-30 nm, for example in the range of 18-25 nm or 20-30 nm, such as about 25 nm. The titanium dioxide may be in an anatase form, in a rutile form or in a brookite form, or as a mixture thereof, such as a mixture of anatase and rutile.

The dispersion of titanium dioxide nanoparticles may be an aqueous dispersion of titanium dioxide nanoparticles, and it may comprise alcohol, such as methanol or ethanol, preferably methanol. The dispersion of titanium dioxide nanoparticles may be provided in predispersed form, wherein the dispersion may comprise one or more additives for stabilizing and maintaining the titanium dioxide nanoparticles dispersed, and/or the titanium dioxide nanoparticles may be predispersed with methods facilitating the stability of the dispersion. The dispersion may contain minor amount additives customary in the art, such as stabilizing agents and/or pH adjusting agents. The dispersion may contain one or more stabilizing agents, such as one or more surfactant(s), such as cationic surfactant(s), for example sodium dodecyl sulphate (SDS), sodium dodecyl benzene sulphonate (SDBS), cetyltrimethylammonium bromide (CTAB), PluronicF-127, TritonX-100, polyethylene glycol, polyvinyl pyrrolidone, poly(ethylene glycol)-poly(propylene glycol)-poly(ethylene glycol) triblock copolymer and/or the like, and/or other stabilizing agents. The amount of the one or more stabilizing agents may be for example in the range of 0.1-3 wt %.

The dispersion may have a pH at a substantially neutral range, such as in the range of 6-8. The pH may be obtained and/or maintained by including one or more pH adjusting agent(s), such as buffering agent(s). Especially when stabilizing agents were used, it was possible to maintain the titanium dioxide nanoparticles well dispersed also at such neutral pH range, also in the sols, which enabled providing safe dispersion and use of the dispersions. Previously it has been necessary to use acidic pHs to maintain the dispersion, which however resulted in dispersions and compositions with harmful properties and reduced usability.

In general, a dispersion is a system in which distributed particles of one material are dispersed in a continuous phase of another material. In general, dispersions of particles sufficiently large for sedimentation are called suspensions, while those of smaller particles, such as the present dispersions, may be called colloids and solutions. In the present dispersions sedimentation was avoided.

The reaction may be carried out in a suitable reactor or container, wherein a reaction mixture is provided. The reaction mixture may be ultrasonicated to disperse the titanium dioxide nanoparticles prior adding the gold and/or silver precursor compound(s). During the process the reaction mixture may be purged with inert gas, such as nitrogen, to remove oxygen or other gases from the mixture. One or more source(s) of UV light is/are provided, and the reaction mixture is illuminated with UV light for a time period suitable for obtaining desired photodeposition, for example a time period of 10-100 minutes, such as 10-80 minutes. The degree of photodepositions can be controlled by adjusting the illumination time, the intensity of the UV light, distance of the UV source(s) and/or other process conditions. After the photodeposition the obtained photocatalytic nanoparticles can be purified, isolated and/or recovered, for example by centrifuging, and they may be dried at an elevated temperature, such as at about 70° C., for several hours or even overnight. The purified, isolated and/or dried nanoparticles may be dispersed into an aqueous solution to obtain a sol. The aqueous solution or the obtained sol may contain or adjusted to contain one or more, or all, of the additives discussed herein. Alternatively the nanoparticles may be recovered and obtained as a sol already after the photodeposition, so in such case the nanoparticles may not be purified, centrifuged and/or dried.

The method comprises providing gold and/or silver compound(s), which may be called as precursor compound(s), for example in the form of suitable salts. The gold and/or silver compounds may be deposited onto the titanium dioxide nanoparticles, such as with the photodepositing methods disclosed herein. For example, gold may be provided as gold chloride, and silver may be provided as silver nitrate.

The gold and silver may be provided in amounts enabling obtaining a desired composition of gold and/or silver in the final photocatalytic plasmonic nanoparticles. The materials are covalently bound to each other. Materials being separate in a final dispersion or sol, such as titanium dioxide and gold and/or silver, which are not covalently bound to each other, cannot provide the present plasmon resonance effect, and represent different catalytic materials.

In one embodiment the amount of gold and/or silver nanoparticles in the photocatalytic plasmonic nanoparticles is in the range of 0.07-0.30% by weight, such as in the range of 0.08-0.25% by weight.

With the photodeposition method it is possible to obtain such deposition of gold and/or silver of the titanium dioxide nanoparticles, which was found to enhance the desired plasmon resonance effect and catalytic properties, especially after the photocatalytic material is applied on surfaces. The gold and/or silver is deposited onto the titanium dioxide nanoparticles in form of nanoparticles having optimal diameters and composition. In one embodiment the average diameter of the gold and/or silver deposited titanium dioxide nanoparticles is in the range of 10-30 nm, such as 10-25 nm. The average diameters disclosed herein may be number-average diameters. The dimensions of the nanoparticles can be determined for example by electron microscopy such as TEM or SEM and/or by energy dispersive X-ray spectroscopy (EDX), such as by EDX line scan analysis. Energy dispersive X-ray spectroscopy is an analytical method for analytical or chemical characterization of materials. EDX systems are generally attached to an electron microscopy instrument such as transmission electron microscopy (TEM) or scanning electron microscopy (SEM). EDX is based on the emission of a specimen characteristic X-rays. A beam of high energy charged particles (electrons or protons) are focused into the investigated sample. An electron from a higher binding energy electron level falls into the core hole and an X-ray with the energy of the difference of the electron level binding energies is emitted. EDX analysis gives a spectrum that displays the peaks correlated to the elemental composition of the investigated sample. In addition, the elemental mapping of a sample can be created with this characterization method.

Au and Ag signals were detected from bimetallic gold and silver deposited TiO₂ nanoparticles by using EDX line scan analysis. In case of Ag—Au/TiO₂, Au signals were detected only in an inner core having an average diameter of about 13-18 nm and Ag signals were observed on the surface of nanoparticle forming a shell having an average thickness of about 2-5 nm. Therefore, it was confirmed that specific morphology, i.e. a gold-core silver-shell structure was formed, which can be obtained only when gold is photodeposited first.

The gold and silver may be provided to obtain bimetallic gold and silver depositions on the titanium dioxide nanoparticles. It was found out that bimetallic deposition enhances the catalytic properties, especially in coatings. Especially it was found out that the deposition order had a strong effect to the photocatalytic properties at a visible range. When gold was first deposited and silver was deposited after this, significantly better catalytic efficiency was obtained. With such method a gold core is obtained having a silver deposited or coated on the core. The core may be in nanoparticle form.

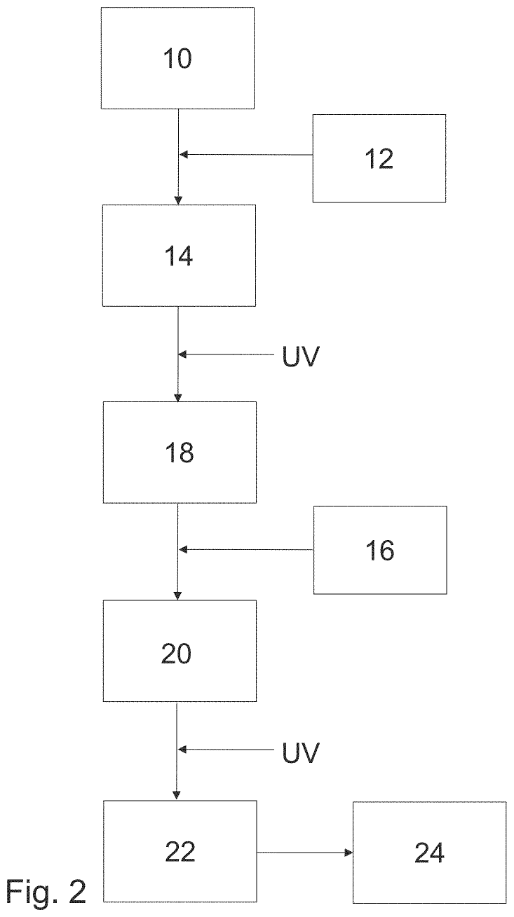

In one embodiment as disclosed in FIG. 2 the method comprises
providing a dispersion of titanium dioxide nanoparticles 10,
providing gold precursor compound(s) 12 to the dispersion 10 to obtain a dispersion 14 comprising titanium dioxide nanoparticles and gold 12 precursor compound(s),
illuminating the dispersion 14 with ultraviolet light (UV) to photodeposit gold nanoparticles onto the titanium dioxide nanoparticles to obtain a dispersion 18 comprising gold nanoparticles deposited on the titanium dioxide nanoparticles,
providing silver precursor compound(s) 16 to the dispersion 18 comprising the gold nanoparticles deposited on the titanium dioxide nanoparticles to obtain a dispersion 20 comprising gold nanoparticles deposited on the titanium dioxide nanoparticles, and silver precursor compound(s) 16,
illuminating the dispersion 20 with ultraviolet light (UV) to photodeposit silver onto the gold nanoparticles deposited on the titanium dioxide nanoparticles to obtain a dispersion 22 comprising photocatalytic plasmonic nanoparticles having a resonance frequency in visible spectrum of electromagnetic radiation and comprising bimetallic silver and gold nanoparticles deposited on the titanium dioxide nanoparticles, and
providing the photocatalytic plasmonic nanoparticles as a degradative sol 24.

Therefore, in one embodiment the photocatalytic plasmonic nanoparticles comprise or consist of bimetallic silver and gold nanoparticles deposited on the titanium dioxide nanoparticles, such as covalently coupled. The photodeposition method was especially advantageous for providing highly active bimetallically deposited photocatalytic plasmonic nanoparticles, which also were ideal for coating different surfaces.

In one embodiment the bimetallic gold and silver nanoparticles comprise gold in or as a core, preferably the gold is present as a core having an average diameter in the range of 10-18 nm or 12-18 nm, such as about 14 nm, and silver is present on the gold as a shell having an average thickness in the range of 2-6 nm, such as about 4 nm, determined by using EDX line scan analysis. The average diameter of the bimetallic silver and gold nanoparticles may be in the range of 15-30 nm.

It was also found out that the percentages of gold and silver in the bimetallic deposition, has an effect to the sensitivity of the plasmon resonance effect to the wavelength of the light. By varying the surface-to-bulk concentration ratio of Ag—Au alloy nanoparticles, the localized surface plasmon resonance (LSPR) can be tuned to the specific wavelengths. For example, 25% Ag/75% Au yields LSPR at 550 nm; 20% Ag/80% Au yields LSPR at 600 nm; 15% Ag/85% Au yields LSPR at 650 nm; 10% Ag/90%Au yields LSPR at 700 nm and 5% Ag/95% Au yields LSPR at 750 nm. The numerical values may be considered approximately (“about”). “Tuned” as used herein refers to obtaining a specific weight ratio of gold and silver exhibiting optimal or maximum LSPR at a specific wavelength, wherein said optimal or maximum LSPR at a specific wavelength is dependent on said weight ratio of gold and silver. Said optimal or maximum LSPR therefore substantially corresponds to a specific wavelength. Preferably the bimetallic silver and gold nanoparticles have silver content in the range of 5-25% by weight and gold content in the range of 95-75% by weight, the sum thereof being 100%. The specific wavelength may comprise any wavelength or wavelength range disclosed herein, for example wavelength in the range of 540-760 nm, such as 550-750 nm, which is in the visible spectrum of electromagnetic radiation. There may be one or more specific wavelength(s), for example if the used or provided light includes one or more wavelength maximums. In case of more than one wavelength maximum, it is possible to provide more than one type of catalytic particles exhibiting corresponding number of optimal or specific LSPRs, such as two or three.

The higher percentage of gold refers to the core, and the lower percentage to the silver deposit, shell or coating on the gold core. The percentages are by weight and approximate, as well as the wavelength values. One or more of the disclosed options may be selected to obtain photocatalytic material with desired properties, such as tailored for certain conditions or a target. The disclosed ratios and percentages may be obtained by controlling the photodeposition process to obtain desired amounts of gold and silver.

Therefore, it is possible to use a specific composition of the bimetallic deposition to obtain a specific wavelength sensitivity. This enables optimizing the coating composition to specific conditions. For example, it is possible to provide a specific antimicrobial coating composition for a target having a specific type of lightning, such as a public place lighted with a specific-colored light and/or a specific light source. This enables obtaining the optimal catalytic activity even at challenging conditions, so the material can be tailored according to the target and not vice versa, as it has been previously the case as the prior art materials have required using a specific light to obtain an efficient photocatalytic activity. Providing such specific light is not always possible, and it is not even desired to use for example ultraviolet light at public places, or other strong light with undesired tone. On the other hand, it is also possible to provide one or more specific light sources, such as a type of light source, such as LED source(s), having one or more specific wavelength maximum(s), and use a photocatalytic coating having corresponding wavelength sensitivity. This can be easily implemented indoors, as such LED sources or other suitable light sources are well available and inexpensive, consume little electricity, are easy to install at desired locations, and provide intensive light, which may be substantially monochromatic. Such electric light sources are controllable, such as electrically controllable, wherein the illuminating time, intensity and/or even the wavelength of the light can be controlled. It is possible to control the lightning, for example by time of lightning, so that the light source is arranged to provide different lightning profile at different times, for example first type of lightning at first lightning period, such as at daytime, office time, open time of public facilities or the like, and a second time of lightning at a second lightning period, such as at night-time, after office or other open time, or the like. The intensity and/or the wavelength of the light may be different between the first and the second lightning period, for example more intense lightning and/or lightning with different wavelength profile may be provided at the second lightning period. The number of active light sources may be different at different lightning periods. In this way more efficient catalytic activity and therefore degradation effect may be obtained at the second lightning period and such light may be used that is not desired during the first period. In is also possible to use more intense lightning or wavelength profile providing more efficient catalytic activity at the first lightning period. There may be also more than two lightning periods, each having a dedicated lightning profile.

In examples the composition of the bimetallic gold and silver is selected from about 5% by weight silver and about 95% by weight gold, about 10% by weight silver and about 90% by weight gold, about 15% by weight silver and about 85% by weight gold, about 20% by weight silver and about 80% by weight gold, and about 25% by weight silver and about 75% by weight gold, or from any ranges between thereof.

With the methods it is possible to obtain degradative sols, either directly from the methods described in previous, or by further adjusting the obtained dispersion. The degradative sols exhibited homogenous distribution of nanoparticles, and the nanoparticles could remain dispersed for a prolonged time without aggregating. This enables a long shelf life and facilitates storing, transporting and handling of the dispersions. The degradative sols can be provided as final products, such as packed products, which may be provided to customers for their desired end uses, for example by applying with desired methods.

The dispersions or sols can be applied as coating compositions. A coating composition may contain the photocatalytic nanoparticles and one or more additives, such as additives customary in the art, including one or more pH adjusting agents, one or more stabilizing agents, and the like substances. A variety of coating methods can be applied, such as any applications methods by brushing, dipping and the like, but also methods including spraying, which are more challenging and require homogenous and sprayable dispersion. The present dispersions or sols were found to have excellent spraying properties, and an even distribution of nanoparticles onto different surfaces could be obtained. Further, with the present dispersions it was possible to obtain relatively thin coating with efficient catalytic properties, which saves material and enables obtaining acceptable coated surfaces in a variety of targets.

The production chain for preparing the catalytic materials, the sols, and using the materials for coating surfaces at target, and further using the catalytic properties at targets, may require several operators, each carrying out one or more steps in the chain. For example, one or more operators may provide the raw materials and reagents, one operator may prepare the sol, one operator may sell the sol, one operator may apply the sol, one operator may administer the target or use a surface for specific purpose and so on. Alternatively, one operator may carry out two or more of said operations. Therefore, it is important that the materials tolerate handling, storing and transporting required in the operations as well as the application of the material at targets, and using the obtained catalytic or degradative properties. It is also important that the different operators can carry out the necessary actions without problems, and preferably no specific knowledge or further processing of the materials are required. In this way it is possible to enable a wide variety of targets, utilize different operations without heavy education, and to obtain repeatable results. With photocatalytic coating product with high quality and which is applicable to a variety of targets and surfaces, it is possible to provide a coating product to a variety of operators (customers), who can carry out any desired surface treatments at their end with the product. Therefore, the properties of the product do not limit the possible end uses but rather enable a wider variety of end uses and end users compared to prior art materials, which may be for example tailored to a specific use and must be applied by specific techniques. The properties of the materials must be uniform, and the materials must be easily usable so any problems can be avoided. With the present methods it was possible to obtain materials which fulfill the requirements, and which can provide said desired properties.

The present disclosure provides a degradative sol comprising an aqueous dispersion of photocatalytic plasmonic nanoparticles having a resonance frequency in visible spectrum of electromagnetic radiation and comprising gold and/or silver nanoparticles deposited on titanium dioxide nanoparticles. The sol may be obtained with the methods disclosed herein. The sol may be provided as packed into packages. An operator, which is specialized in applying coatings, for example by spraying, can immediately use the provided sol product for coating, and obtain coated degradative surfaces with high quality.

The present disclosure provides a degradative surface, a surface coated with a degradative coating, a surface comprising a degradative coating, and/or a degradative surface coating, which terms may be used interchangeably herein, comprising photocatalytic plasmonic nanoparticles having a resonance frequency in visible spectrum of electromagnetic radiation, the nanoparticles comprising or consisting of gold and/or silver nanoparticles deposited on titanium dioxide nanoparticles. The degradative surfaces may be obtained by using the photocatalytic plasmonic nanoparticles, preferably in the form of the sol, for coating a surface. One example provides an object or a target comprising a surface coated with the degradative sol. The degradative surface may be an antimicrobial surface. The coating may have a thickness ranging from tens of nanometers to several micrometers, for example in the range of 50-5000 nm, such as 50-3000 nm, 50-2000 nm or 50-1000 nm, which may depend on the coating method and amount of sol used. The coating may or may not include thin films.

A coated surface, or a sample obtained from such a surface or coating, may be analyzed to detect the presence of the present catalytic coating. The analysis may include determining the catalytic activity, which may be carried out for example by determining photocatalytic water splitting reaction to produce hydrogen and/or degradation of organic molecule such as methylene blue. The analysis may also include determining the presence and content of the materials gold, silver and titanium dioxide by using methods known in the art, such as ones disclosed herein. It is also required to identify that the coating exhibits plasmonic resonance band within the visible range of wavelengths when absorbance is measured with UV-Vis spectrophotometer. By comparing the catalytic activity and the composition of the material it can be concluded if the material is present in the forms disclosed herein. For example, if a certain catalytic activity is not obtained, but the analysis shows the presence of titanium dioxide and gold and/or silver, it can be concluded that the material is not in the form of photocatalytic plasmonic nanoparticles, but the substances are rather in separate form and not covalently coupled or bound to each other. On the other hand, the presence of bimetallic gold and silver can be detected from a sample.

The photocatalytic plasmonic nanoparticles having a plasmonic resonance frequency in visible spectrum of electromagnetic radiation and comprising gold and/or silver nanoparticles deposited on titanium dioxide nanoparticles exhibits photocatalytic water splitting reaction activity at the visible range of wavelengths producing hydrogen and/or degradation of organic molecule, which is characteristic for photocatalytic plasmonic nanoparticles. The visible range of wavelengths may comprise for example wavelength range of 380-790 nm, 400-760 nm, 540-760 nm, or 550-750 nm.

For example, optical properties of the nanoparticles can be studied using a UV/Vis/NIR spectrophotometer, such as one with an integrating sphere detector. The diffuse reflectance spectra may be recorded from 300 nm to 750 nm. Photocatalytic hydrogen production can be analyzed using a gas chromatograph (GC) using nitrogen as the carrier gas. The metal loading on catalyst nanocomposites can be analyzed by inductively coupled plasma mass spectrometry (ICP-MS). For the ICP-MS analysis, solid samples may be first completely dissolved in HF/HNO₃ solution using a microwave digestion system. XPS measurements may be carried out using Al Kα (hv=1486.6 eV) excitation and constant pass energy of 100 eV. The data can be analyzed using a dedicated software. The binding energy scale may be calibrated according to C 1s (C—C/H) at 284.4 eV.

The surface may be any applicable surface, which may be called a target, or a surface may be a part of a target or an object. Applicable targets or surfaces include any suitable targets or surfaces, such as any objects, walls, planes, handles, or the like, which may be prone to contamination with microbes or other undesired substances comprising degradable organic and/or inorganic substances, or which are in contact with such substances. For example, public places may be treated with the present materials, as well as surfaces at home. Public places may include swimming pools, gyms and skating rinks; shops, shopping centers and restaurants; museums, theatres, cinemas and libraries; concert halls and event centers; hotels, ski resorts and spas; vehicles and car rental shops; playgrounds and amusement parks; terminals, stations and ports; hairdressers and beauty salons; assisted living facilities and wellness centers; kindergartens and schools; hospitals, health centers and dental clinics; offices and agencies, elevators, and any other applicable targets. Especially surfaces at vehicles can be coated, such as surfaces at public transport vehicles such as buses, trains, trams, airplanes, boats, and also cars and other vehicles. The targets may be indoor and/or outdoor targets. The targets may include different kind of surfaces at one target, so it is not required to provide different types of coatings for different types of surfaces, but the same sol could be used for coating large areas or rooms. It is possible to treat and coat very large surfaces and areas. Examples of specific targets and surfaces at the targets include door handles, surfaces at kitchens, toilets and bathrooms, tables, seats, walls, handrails, columns, and the like. Different materials may be treated, such as ceramics, for example tiles, metal, concrete, wood, plastics, composites, painted surfaces, glass and the like. The targets may include fixed targets but also separate objects, which are movable or transportable, for example small objects such as handheld objects. For example consumer goods may be provided with the present degradative or antimicrobial coatings.

With the active degradative surfaces, the hygiene level of the targets can be enhanced, and the risk of spreading infectious diseases is minimized. Also, the need for using chemicals for cleaning or sterilizing surfaces is reduced, which therefore also reduces exposure to irritating or harmful chemicals.

The present materials and surfaces are also applicable for industrial use, for example for treating water, aqueous solutions, aqueous dispersions, waste waters or other waste solutions or dispersions, and/or for obtaining antimicrobial surfaces for industrial use and industrial locations, for example in factories, plants, other productions facilities, waste treatment and/or recycling, especially for purifying waters and waster waters. For example, it is possible to use the present materials and method for carrying out Fenton process or Fenton-like process, which can be used for treating waste waters, such as to disinfect the water, and/or to remove harmful or hazardous organic pollutants, but without using harmful reagents to generate hydroxyl radicals and hydrogen peroxide.

It was found out that the present sols were efficiently evaporated after coating, for example in 24 hours, and the photocatalytic plasmonic nanoparticles remained on the surface and maintained their catalytic activity for a long time. Especially coatings at public places or other challenging environment are exposed to several factors which tend to deteriorate any coating, and especially catalytic coatings. For example, heat, cold, direct sunlight, dry conditions, humid conditions, wear, such as by touching, cleaning etc., exposure to oxygen, solvents, detergents and/or contaminants, and the like factors can easily destroy the catalytic activity and integrity of a coating. This was however not the case with the present coatings, but they maintained their activity and integrity at a variety of challenging conditions.

This effect was found to relate at least to the properties of titanium dioxide nanoparticles, which maintain their redox properties at ambient conditions and when attached on the target, which properties are essential to the present catalytic properties utilizing plasmon resonance. By using titanium dioxide nanoparticles, it was possible to obtain inexpensive and stable material for the variety of coating purposes discussed herein, which would have been more challenging if other types of materials would have been used as the semiconducting material.

The present disclosure provides a method for providing catalytically active degradative surface, the method comprising
providing the degradative sol,
coating a surface with the degradative sol, to obtain a catalytically active degradative surface, such as photocatalytically active degradative surface. The method may comprise first providing a surface, or an object comprising the surface, and then coating the surface.

In one embodiment the coating comprises spraying the degradative sol onto the surface. Any suitable means for obtaining a spray may be used, such as a sprayer or an atomizer. The spraying may be carried out by providing pressurized sol and conveying this through a spray nozzle to atomize the sol. “Atomizing” as used herein refers to reducing to a fine spray. It is desired to obtain a spray with very fine particles and even distribution, which usually requires a spray nozzle with a small orifice. This also set requirements for the sol to be sprayed. It was found out that the sols obtained with the present methods were in such form that a desired spray could be easily obtained, and the nanoparticles remained well dispersed in the sol, so no aggregates were formed which could interfere the spraying process. Therefore, it is desired to obtain a sprayable dispersion, which preferably fulfills the requirement for spraying as discussed herein. For example, a dispersion with aggregated nanoparticles and/or otherwise having too viscous or unsuitable composition may not be considered sprayable.

The coating may also comprise other coating methods, such as applying by brushing, dipping, immersing, roll coating, spin coating, flow coating or the like. The coating may be carried out manually or it may be automated, for example it may be an industrial process. The properties of the sol do not play as great role in all coating methods, but in processes like spraying and certain industrial processes it must be confirmed that the used sol does not limit or prevent the application by the selected method.

After coating the treated surface is allowed a dry so that the water and optionally alcohol present in the formed or forming coating is evaporated. The drying may take for example up to 24 hours, so it is important that the material remains at the surface during drying and maintains its activity. A dried coating or coated surface is obtained, wherein the nanoparticles are bound to the surface and exhibits the catalytic properties disclosed herein. The obtained surface may be called a degradative surface, catalytic surface, such as photocatalytic surface, and/or an antimicrobial surface.

The present materials can be used for providing antimicrobial properties by degrading microbes, but it is also possible to degrade other organic and/or inorganic substances by using the same catalytic properties.

The present disclosure provides a method for degrading organic substances, such as eliminating microbes, the method comprising
providing the degradative surface,
allowing the photocatalytic plasmonic nanoparticles to catalytically degrade organic substances on the surface.

It may be possible to provide and use the photocatalytic plasmonic nanoparticles instead of the surfaces also in other forms, such as in solutions or dispersions, or in other ways. However, the term “surface” as used herein may be interpreted broadly including not only solid or hard surfaces such as walls, levels, or the like objects, such also surfaces on objects such as textiles, fibers, papers, boards, solid foams and the like.

The present materials exhibit photocatalytic properties, but they also exhibit other catalytic properties, which do not require light and/or oxygen. Therefore, the materials may also provide catalytic activity, such as degradative or antimicrobial activity, also in dark or at very low light. For example, silver may be used in such materials. In one example Ag nanoparticles with 0.07-0.30% by weight, such as 0.08-0.25% by weight, loading deposited on titanium oxide nanoparticles are provided exhibiting antimicrobial properties due to their nanostructure, the stability of which is promoted by the redox properties of the titanium oxide nanoparticles. This synergetic effect makes Ag nanoparticles degradative towards micro-organism even in non-luminous and oxygen-deficient conditions. The specific size of the silver nanoparticles creates electronic states, which are coupled with the enhanced charge carrier transfer dynamics due to plasmonic interaction and yields catalytically active surface sites for degrading the micro-organism. Under oxidative condition the Ag nanoparticles remain active due to the redox reactions mediated by titanium oxide nanoparticles.

In embodiments the photocatalytic plasmonic nanoparticles are allowed to catalytically degrade organic and/or inorganic substances in the (substantial) absence of light, in the absence of oxygen and/or in the presence of light and/or oxygen.

In many cases light may be used. In one embodiment the method comprises illuminating the surface with light with a wavelength in the range of 540-760 nm. The illuminating refers to providing light and/or providing the materials at a target which provides the light, at least at a part of the time.

In one embodiment, wherein the photocatalytic plasmonic nanoparticles comprise or consist of bimetallic silver and gold nanoparticles deposited on the titanium dioxide nanoparticles, the method comprises illuminating the surface with light with a wavelength maximum corresponding to the localized surface plasmon resonance (LSPR) maximum of the photocatalytic plasmonic nanoparticles, for example selected from
about 550 nm if the bimetallic gold and silver alloy comprises about, 25% by weight silver and about 75% by weight gold,
about 600 nm if the bimetallic gold and silver alloy comprises about, 20% by weight silver and about 80% by weight gold,
about 650 nm if the bimetallic gold and silver alloy comprises about 15% by weight silver and about 85% by weight gold,
about 700 nm if the bimetallic gold and silver alloy comprises about 10% by weight silver and about 90% by weight gold, and
about 750 nm if the bimetallic gold and silver alloy comprises about 5% by weight silver and about 95% by weight gold.

The method may comprise selecting and providing a suitable light source, a suitable wavelength and/or the composition of the bimetallic silver and gold nanoparticles to illuminate the object with the light with said wavelength. One or more light source(s), such as controllable electric light source(s), may be provided and/or used, for example such one(s) wherein a desired wavelength, such as wavelength maximum or wavelength range, of the light can be controlled, adjusted, provided and/or obtained. Different lightning profiles may be applied, as well as lightning periods. More particularly the method may comprise obtaining or providing information on the lightning at the intended target, such as a light spectra of the target light, preferably directed to an intended surface to be coated, finding one or more wavelength maximum(s) or peak(s) in the spectra, selecting one or more photocatalytic plasmonic nanoparticles having a composition of the bimetallic gold and silver alloy corresponding to the one or more maximum(s) or peak(s), and providing the selected one or more photocatalytic plasmonic nanoparticles in the form of sol for coating a surface at the target. The method may therefore include preparing a tailored degradative composition in the form of a sol. The composition may be provided to another operator who carries out the actual coating at the target.

In one embodiment the method comprises
obtaining information on the lightning at a target directed to the intended coatable surface, the information comprising one or more wavelength maximum(s), preferably in the range of 540-760 nm,
selecting photocatalytic plasmonic nanoparticles comprising or consisting of bimetallic silver and gold nanoparticles deposited on the titanium dioxide nanoparticles and having a localized surface plasmon resonance (LSPR) tuned to (corresponding to) at least one of the one or more wavelength maximum(s), and
providing the selected photocatalytic plasmonic nanoparticles in the form of sol for coating the surface at the target, optionally coating the surface at the target.

In one embodiment the method comprises
obtaining information on the lightning at a target directed to the intended coatable surface, the information comprising one or more wavelength maximum(s), preferably in the range of 540-760 nm,
selecting photocatalytic plasmonic nanoparticles comprising or consisting of bimetallic silver and gold nanoparticles deposited on the titanium dioxide nanoparticles, wherein the bimetallic silver and gold nanoparticles have silver content in the range of 5-25% by weight and gold content in the range of 95-75% by weight, the sum being 100%,
wherein the selected weight ratio of gold and silver determines a localized surface plasmon resonance (LSPR) tuned to at least one of the one or more wavelength maximum(s), and
providing the selected photocatalytic plasmonic nanoparticles in the form of sol for coating the surface at the target, optionally coating the surface at the target.

The present disclosure also provides use of the photocatalytic plasmonic nanoparticles and use of the degradative sol for coating a surface and for catalytically degrading substances, such as organic and/or inorganic substances, for example microbes. The coatings and catalytic uses may be as disclosed herein.

The following numbered examples disclose embodiments of the present application.

1. A method for preparing a degradative sol, such as an antimicrobial sol, preferably a sprayable sol, the method comprising
providing an aqueous dispersion of titanium dioxide nanoparticles, preferably comprising alcohol, such as methanol,
providing gold and/or silver precursor compound(s) to the dispersion,
optionally removing gases from the dispersion,
illuminating the dispersion with ultraviolet light to photodeposit gold and/or silver nanoparticles onto the titanium dioxide nanoparticles to obtain photocatalytic plasmonic nanoparticles having a plasmonic resonance frequency in visible spectrum of electromagnetic radiation, and
providing the photocatalytic plasmonic nanoparticles as a degradative sol, preferably forming the photocatalytic plasmonic nanoparticles into a degradative sol.

2. The method of example 1, comprising
providing gold precursor compound(s) to the dispersion,
illuminating the dispersion with ultraviolet light to photodeposit gold nanoparticles onto the titanium dioxide nanoparticles to obtain gold nanoparticles deposited on the titanium dioxide nanoparticles,
providing silver precursor compound(s) to the dispersion comprising the gold nanoparticles deposited on the titanium dioxide nanoparticles,
illuminating the dispersion with ultraviolet light to photodeposit silver onto the gold nanoparticles deposited on the titanium dioxide nanoparticles to obtain photocatalytic plasmonic nanoparticles having a plasmonic resonance frequency in visible spectrum of electromagnetic radiation and comprising bimetallic silver and gold nanoparticles deposited on the titanium dioxide nanoparticles, and
providing the photocatalytic plasmonic nanoparticles as an antimicrobial sol.

3. A degradative sol, such as an antimicrobial sol, comprising an aqueous dispersion of photocatalytic plasmonic nanoparticles having a plasmonic resonance frequency in visible spectrum of electromagnetic radiation and comprising gold and/or silver nanoparticles deposited on titanium dioxide nanoparticles.

4. A degradative surface, such as an antimicrobial surface, coated with photocatalytic plasmonic nanoparticles having a resonance frequency in visible spectrum of electromagnetic radiation and comprising gold and/or silver nanoparticles deposited on titanium dioxide nanoparticles.

5. The method of examples 1 or 2, the degradative sol of example 3, or the surface of example 4, wherein the amount of gold and/or silver nanoparticles in the photocatalytic plasmonic nanoparticles is in the range of 0.07-0.30% by weight, such as in the range of 0.08-0.25% by weight.

6. The method of examples 1, 2 or 5, the degradative sol of examples 3 or 5, or the surface of examples 4 or 5, wherein the average diameter of the titanium dioxide nanoparticles is in the range of 10-50 nm, such as 10-30 nm.

7. The method of examples 1, 2 or 5-6, the degradative sol of examples 3, 5 or 6, or the surface of any of the examples 4-8, wherein the average diameter of the gold and/or silver nanoparticles is in the range of 10-25 nm.

8. The method of examples 1 or 2, the degradative sol of example 3 or any of the examples 5-7, or the surface of any of the examples 4-7, wherein the photocatalytic plasmonic nanoparticles comprise or consist of bimetallic silver and gold nanoparticles deposited on the titanium dioxide nanoparticles.

9. The method of example 8, the degradative sol of example 8, or the surface of example 8, wherein the bimetallic gold and silver nanoparticles comprise gold in or as a core, preferably the gold is present as a core having an average diameter in the range of 10-18 nm or 12-18 nm, and silver is present on the gold as a shell having an average thickness in the range of 2-6 nm, determined by using EDX line scan analysis.

10. The method of any of the examples 8-9, the degradative sol of any of the examples 8-10, or the surface of any of the examples 8-9, wherein the composition of the bimetallic gold and silver is selected from about 5% by weight silver and about 95% by weight gold, about 10% by weight silver and about 90% by weight gold, about 15% by weight silver and about 85% by weight gold, about 20% by weight silver and about 80% by weight gold, and about 25% by weight silver and about 75% by weight gold.

11. A method for providing a degradative surface, such as an antibacterial surface, the method comprising
providing the degradative sol of any of the examples 3 or 5-10,
coating a surface with the degradative sol, to obtain a catalytically active degradative surface coated with photocatalytic plasmonic nanoparticles having a resonance frequency in visible spectrum of electromagnetic radiation and comprising gold and/or silver nanoparticles deposited on titanium dioxide nanoparticles, such as photocatalytically active degradative surface.

12. The method of example 11, comprising
obtaining information on the lightning at a target directed to the intended coatable surface, the information comprising one or more wavelength maximum(s), preferably in the range of 540-760 nm,
selecting photocatalytic plasmonic nanoparticles comprising or consisting of bimetallic silver and gold nanoparticles deposited on the titanium dioxide nanoparticles having a localized surface plasmon resonance (LSPR) tuned to (corresponding to) at least one of the one or more wavelength maximum(s), and
providing the selected photocatalytic plasmonic nanoparticles in the form of sol for coating the surface at the target, optionally coating the surface at the target.

13. The method of example 11 or 12, comprising
obtaining information on the lightning at a target directed to the intended coatable surface, the information comprising one or more wavelength maximum(s), preferably in the range of 540-760 nm,
selecting photocatalytic plasmonic nanoparticles comprising or consisting of bimetallic silver and gold nanoparticles deposited on the titanium dioxide nanoparticles, wherein the bimetallic silver and gold nanoparticles have silver content in the range of 5-25% by weight and gold content in the range of 95-75% by weight, the sum being 100%,
wherein the selected weight ratio of gold and silver determines a localized surface plasmon resonance (LSPR) tuned to at least one of the one or more wavelength maximum(s), and
providing the selected photocatalytic plasmonic nanoparticles in the form of sol for coating the surface at the target.

14. The method of any of the examples 11-13, wherein the coating comprises spraying the degradative sol onto the surface.

15. A method for degrading organic substances, such as eliminating microbes, the method comprising
providing the degradative surface of any of the examples 4-10,
allowing the photocatalytic plasmonic nanoparticles to catalytically degrade organic substances on the surface, optionally in the absence of light, in the absence of oxygen and/or in the presence of light and/or oxygen.

16. The method for degrading organic substances of example 15, comprising
illuminating the surface with light with a wavelength in the range of 540-760 nm.

17. The method of example 16, wherein the photocatalytic plasmonic nanoparticles comprise or consist of bimetallic silver and gold nanoparticles deposited on the titanium dioxide nanoparticles, the method comprising illuminating, preferably selecting and providing a suitable light source and/or the composition of the bimetallic silver and gold nanoparticles to illuminate, the surface with light with a wavelength maximum corresponding to the localized surface plasmon resonance (LSPR) maximum of the photocatalytic plasmonic nanoparticles, for example of about 550 nm if the bimetallic gold and silver alloy comprises about, 25% by weight silver and about 75% by weight gold,
about 600 nm if the bimetallic gold and silver alloy comprises about, 20% by weight silver and about 80% by weight gold,
about 650 nm if the bimetallic gold and silver alloy comprises about 15% by weight silver and about 85% by weight gold,
about 700 nm if the bimetallic gold and silver alloy comprises about 10% by weight silver and about 90% by weight gold, or
about 750 nm if the bimetallic gold and silver alloy comprises about 5% by weight silver and about 95% by weight gold.

### EXAMPLES

In the experiments, mono- and bimetallic Ag—Au/TiO₂ nanocomposites were synthetized by photodeposition in order to investigate the effect of surface plasmon resonance (SPR) property on photocatalytic activity for solar water splitting and methylene blue (MB) degradation. The synthesized catalyst nanoparticles were characterized by UV—Vis-spectroscopy, Raman spectroscopy, X-ray photoelectron spectroscopy (XPS) and Transmission electron microscopy (TEM). The photodeposition times were optimized for monometallic nanocomposites to yield maximum SPR absorption peak intensities in the visible range. It was found that the photocatalytic activity of bimetallic Ag—Au/TiO₂ nanocomposites outperformed monometallic nanocomposites of Ag or Au on TiO₂.

Experimental Section

Materials

Gold chloride (HAuCl₄.3H₂O, Sigma Aldrich, ≥99.9% trace metals basis), silver nitrate (AgNO₃, Sigma Aldrich, BioXtra >99% titration), TiO₂ (Degussa P25, Sigma Aldrich, Aeroxide® P25, ≥99.5% trace metals basis, particle size approximately 21 nm using TEM analysis), methanol (VWR, ≥99.8% ACS) and methylene blue (MB) (Sigma Aldrich, 0.05 wt. % in H₂O) and deionized water (DI) from an ultrafiltration system were used in the work. All the chemicals were used without any further purification.

Mono-Metallic Au/TiO₂ and Ag/TiO₂ Catalyst:

To prepare Au/TiO₂ catalyst nanoparticles, photodeposition method were used in order to deposit Au on TiO₂ surface. In a quartz round bottom flask, 500 mg of TiO₂, 30 ml H₂O and 100 ml methanol were taken in order to prepare TiO₂ slurry. The stock solution of Au with 0.001 M concentration were prepared separately in DI water, out of which 0.25 wt. % of Au precursor (HAuCl₄) were mixed with the TiO₂ slurry. The rubber septum was utilized to seal the quartz reactor containing the slurry. The slurry was then purged with the N₂ gas for 30 minutes by using a long needle inserted through the septum. In order to withdraw oxygen and other remaining gases from the reactor, an additional needle was inserted via septum. Later, the slurry was exposed with UV light (200 W ELC-800 UV lamp, High Pressure 200-Watt DC Short arc mercury vapor lamp) for 40 min. The original pale-yellow color of the slurry was turned to violet-pink after UV exposure. By using centrifugation for 15 minutes at 8000 RPM followed by overnight drying at 70° C., Au/TiO₂ catalyst nanoparticles were recovered.

Ag/TiO₂ catalyst nanoparticles were also prepared similarly using the above procedure. In TiO₂-H₂O-methanol slurry, 0.14 wt. % of Ag precursor was added from the stock solution of 0.001 M AgNO₃. After exposing the slurry by UV light for 20 minutes, the white color of slurry was changed to light orange after UV exposure.

Bimetallic Ag—Au/TiO₂ Catalyst Nanocomposite:

From the prepared mono-metallic catalyst, 500 mg, 40 min photo-deposited Au/TiO₂ nanoparticles were mixed with 30 ml H₂O and 100 ml methanol in a quartz round bottom flask. To obtain well-dispersed slurry of Au/TiO₂, it was sonicated for 30 minutes followed by purging with N₂ gas for 30 minutes. The reactor containing slurry was exposed to UV light for 20 minutes in continuously stirring condition. After that it was centrifuged at 8000 RPM for 15 minutes and dried at 70° C. overnight. In this way the bimetallic Ag—Au/TiO₂ nanocomposite was recovered.

Characterization: UV/Vis/NIR Analysis:

UV/Vis/NIR spectrophotometer analysis (PerkinElmer® LAMBDA 1050 UV/Vis/NIR spectrophotometer) were utilized to study the optical propertied of the synthesized catalyst. The integrating sphere module were used to record the diffuse reflectance spectra between 300 nm to 700 nm.

Photocatalytic Degradation of Methylene Blue:

The photocatalytic activity of the synthesized catalyst was studied by recording the rate of degradation of methylene blue in an aqueous medium. In this experiment, 400 ppm catalyst was added in 50 ml DI water and 2 ppm methylene blue solution (Sigma Aldrich, 0.05 wt. % in H₂O) in a quartz round bottom flask. The mixture was kept in dark for 3 hours in continuously stirring condition. Before exposing it to solar stimulator, 2 ml of sample from the mixture were taken out to record the initial concentration of the methylene blue. The methylene blue-catalyst mixture is then exposed with solar stimulator (HAL-C100, Asahi Spectra Co., Ltd., JIS Class A) and again after every few minutes of exposure, 2 ml of the sample were taken out of the reactor. To separate the catalyst nanoparticles, the series of samples were centrifuged for 15 minutes at 6500 RPM and the remaining uppermost solution was drawn out for further analysis into separate acrylic cuvettes (path length of 10 mm).

The cuvette holder (ThorLabs CVH100) was assembled with laser source (ThorLabs CPS635R, collimated laser diode module, 1.2 mW, 635 nm) and detector (ThorLabs SM1PD1A, silicon photodiode, detection range 350-1100 nm) to establish a stable setup. The attenuation of light reaching the detector in the presence of cuvette containing sample was measured using photodiode amplifier (ThorLabs PDA200C). To obstruct the external light and for better measurement accuracy, the cuvette setup was covered with a black lid. Photodiode currents were initially recorded for the cuvette without containing any sample. Afterwards, one by one the cuvettes containing the sample were introduced into the cuvette holder to record the photodiode current.

Results and Discussion

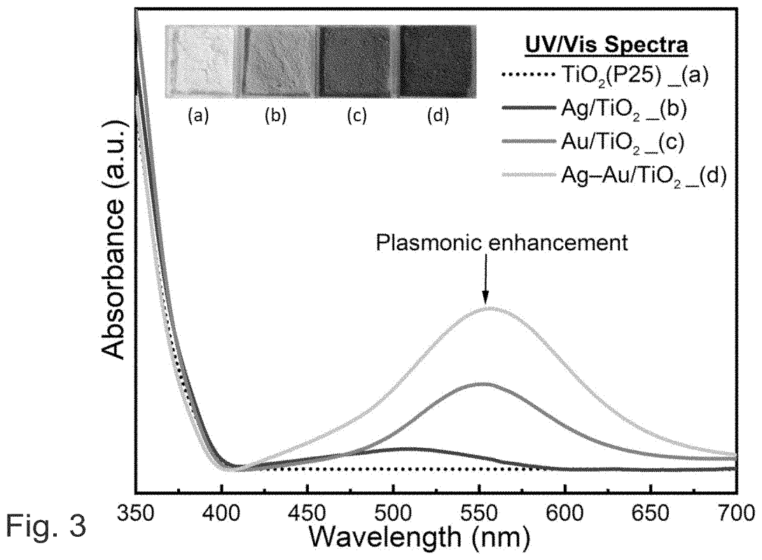

UV/Vis/NIR absorption spectra were recorded for both mono-metallic (Ag/TiO₂) (Au/TiO₂) and bimetallic (Ag—Au/TiO₂) nanoparticles synthesized by photodeposition method. Optical light absorption of the synthesized samples is illustrated in FIG. 3. Bare TiO₂ absorbs only in the UV region of the solar spectrum with absorbance threshold below 400 nm and did not show any signs of visible light absorption in the UV/Vis/NIR spectra. However, TiO₂ with plasmon deposition extends its absorption capacity and covers wider range in visible region. Monometallic Ag/TiO₂ and Au/TiO₂ nanoparticles yield maximum surface plasmon resonance intensity peak at 515 nm and 555 nm respectively whereas in bimetallic (Ag—Au/TiO₂), surface plasmon resonance band intensity increased depicting the combined effect due to surface plasmon resonance of both the metals This indicates that the plasmonic deposition of second metal on TiO₂ exhibit a strong influence on the optical absorption. With the intensity maximum in visible range of solar spectrum, Ag—Au/TiO₂ confirms as the best candidate compared to TiO₂ and monometallic nanoparticles. The strong color change of the initial white TiO₂ after the photodeposition of Au and Ag shows successful metal deposition on TiO₂.

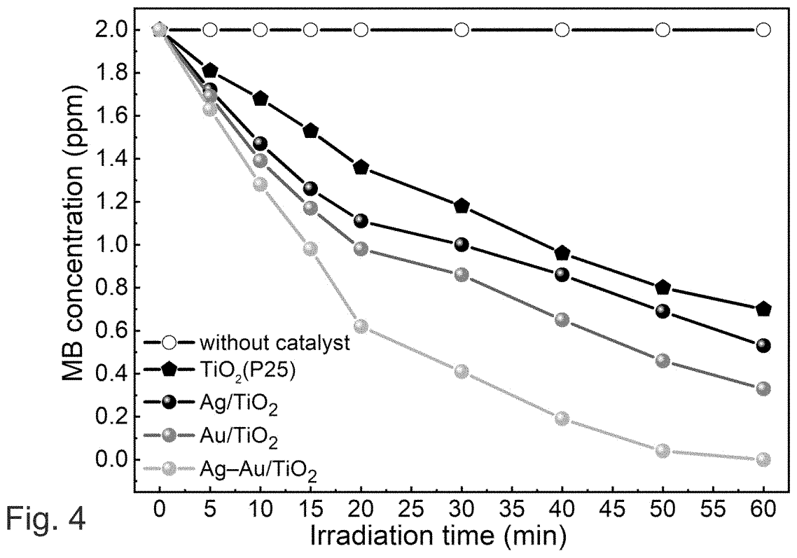

Methylene blue degradation experiments were done further to study the photocatalytic activity of the synthesized catalyst. As the photoirradiation time with UV light increases, the methylene blue concentration starts decreasing slowly. In this experiment, the attenuation of light was measured while it passes through the sample and it was used further to determine the MB concentrations. By measuring the photodiode current, MB concentrations were noted by taking different concentrations of MB aqueous solution. Finally, the calibration curve was plotted for further analysis. Existence of catalyst nanoparticles in MB slurry accelerates the MB degradation process. The results of methylene blue degradation due to presence of catalyst nanoparticles under solar irradiation, which illustrate the photocatalytic activity, are presented in FIG. 4.

The initial MB concentration were recorded as ‘C₀’ (2 ppm). The methylene blue absorption on synthesized catalyst varies with exposure time. Hence the concentration of MB after light exposure were noted as ‘C’ and concentration of MB after exposure relative to initial MB concentration were calculated. As the light exposure continues, the photolysis of MB was observed. Finally, the apparent rate constant (kₐₚₚ) values were determined by plotting —In (C/C₀) against exposure time and tabulated in Table 1. Amongst all the catalyst, Ag—Au/TiO₂ is the most efficient to obtain complete MB degradation.

The (kₐₚₚ) value was maximum for Ag—Au/TiO₂ whereas for TiO₂ it was 2 times lower compared to Ag—Au/TiO₂. Also, monometallic nanoparticles exhibit 1.5 times lower (kₐₚₚ) value compared to Ag—Au/TiO₂.

TABLE 1
Apparent rate constant (Kₐₚₚ) values for Methylene
blue (MB) degradation

| Catalyst | Kₐₚₚ (min⁻¹) |
|---|---|
| No catalyst | 0 |
| TiO₂ | 0.00492 |
| Ag/TiO₂ | 0.00718 |
| Au/TiO₂ | 0.00804 |
| Ag—Au/TiO₂ | 0.01036 |

Conclusions

In the vicinity of plasmonic nanoparticles like Ag and Au, due to their property of surface plasmon resonance, the capacity to harvest the light has extended to visible region of the solar spectrum. The photodeposition of two metals on TiO₂ improves the optical absorption as well as the photocatalytic MB degradation activity significantly compared to bare TiO₂ and single metal deposited samples.

1. A method for preparing a degradative sol, the method comprising:
providing an aqueous dispersion of titanium dioxide nanoparticles;
providing gold and/or silver precursor compound(s) to the dispersion;
illuminating the dispersion with ultraviolet light to photodeposit gold and/or silver nanoparticles onto the titanium dioxide nanoparticles to obtain photocatalytic plasmonic nanoparticles having a plasmonic resonance frequency in visible spectrum of electromagnetic radiation; and
providing the photocatalytic plasmonic nanoparticles as a degradative sol.

2. The method of claim 1, comprising:
providing gold precursor compound(s) to the dispersion;
illuminating the dispersion with ultraviolet light to photodeposit gold nanoparticles onto the titanium dioxide nanoparticles to obtain gold nanoparticles deposited on the titanium dioxide nanoparticles;
providing silver precursor compound(s) to the dispersion comprising the gold nanoparticles deposited on the titanium dioxide nanoparticles;
illuminating the dispersion with ultraviolet light to photodeposit silver onto the gold nanoparticles deposited on the titanium dioxide nanoparticles to obtain photocatalytic plasmonic nanoparticles having a plasmonic resonance frequency in visible spectrum of electromagnetic radiation and comprising bimetallic silver and gold nanoparticles deposited on the titanium dioxide nanoparticles; and
providing the photocatalytic plasmonic nanoparticles as an antimicrobial sol.

3. A degradative sol comprising an aqueous dispersion of photocatalytic plasmonic nanoparticles having a plasmonic resonance frequency in visible spectrum of electromagnetic radiation and comprising gold and/or silver nanoparticles deposited on titanium dioxide nanoparticles.

4. The degradative sol of claim 3, wherein the amount of gold and/or silver nanoparticles in the photocatalytic plasmonic nanoparticles is in a range of 0.07-0.30% by weight.

5. The degradative sol of claim 3, wherein the average diameter of the titanium dioxide particles is in the range of 10-50 nm.

6. The degradative sol of claim 3, wherein the photocatalytic plasmonic nanoparticles comprise or consists of bimetallic silver and gold nanoparticles deposited on the titanium dioxide nanoparticles.

7. The degradative sol of claim 6, wherein the bimetallic gold and silver nanoparticles comprise silver deposited on gold.

8. The degradative sol of claim 7, wherein the gold is present as a core having an average diameter in a range of 10-18 nm or in a range of 12-18 nm, and the silver is present on the gold as a shell having an average thickness in a range of 2-6 nm, determined by using EDX line scan analysis.

9. The degradative sol of claim 6, wherein the composition of the bimetallic gold and silver is selected from about 5% by weight silver and about 95% by weight gold, about 10% by weight silver and about 90% by weight gold, about 15% by weight silver and about 85% by weight gold, about 20% by weight silver and about 80% by weight gold, and about 25% by weight silver and about 75% by weight gold.

10. A degradative surface coated with photocatalytic plasmonic nanoparticles having a resonance frequency in visible spectrum of electromagnetic radiation and comprising gold and/or silver nanoparticles deposited on titanium dioxide nanoparticles.

11. The degradative surface of claim 10, wherein the photocatalytic plasmonic nanoparticles comprise or consist of bimetallic silver and gold nanoparticles deposited on the titanium dioxide nanoparticles.

12. The degradative surface of claim 11, wherein the bimetallic gold and silver nanoparticles comprise silver deposited on gold.

13. The degradative surface of claim 12, wherein the gold is present as a core having an average diameter in a range of 10-18 nm or in a range of 12-18 nm, and the silver is present on the gold as a shell having an average thickness in the range of 2-6 nm, determined by using EDX line scan analysis.

14. A method for providing a degradative surface, the method comprising:
providing the degradative sol of claim 3; and
coating a surface with the degradative sol, to obtain a catalytically active degradative surface coated with photocatalytic plasmonic nanoparticles having a resonance frequency in visible spectrum of electromagnetic radiation and comprising gold and/or silver nanoparticles deposited on titanium dioxide nanoparticles.

15. The method of claim 14, comprising:
obtaining information on the lightning at a target directed to the intended coatable surface, the information comprising one or more wavelength maximum(s);
selecting photocatalytic plasmonic nanoparticles comprising or consisting of bimetallic silver and gold nanoparticles deposited on the titanium dioxide nanoparticles, wherein the bimetallic silver and gold nanoparticles have silver content in a range of 5-25% by weight and gold content in a range of 95-75% by weight, the sum being 100%;
wherein the selected weight ratio of gold and silver determines a localized surface plasmon resonance (LSPR) tuned to at least one of the one or more wavelength maximum(s); and
providing the selected photocatalytic plasmonic nanoparticles in the form of sol for coating the surface at the target.

16. A method for degrading organic substances, the method comprising:
providing the degradative surface of claim 10; and
allowing the photocatalytic plasmonic nanoparticles to catalytically degrade organic substances on the surface, optionally in the absence of light, in the absence of oxygen and/or in the presence of light and/or oxygen.

17. The method for degrading organic substances of claim 16, comprising illuminating the surface with light with a wavelength in a range of 540-760 nm.

18. The method of claim 17, wherein the photocatalytic plasmonic nanoparticles comprise or consist of bimetallic silver and gold nanoparticles deposited on the titanium dioxide nanoparticles, the method comprising selecting and providing a suitable light source and/or the composition of the bimetallic silver and gold nanoparticles to illuminate the surface with light with a wavelength maximum corresponding to the localized surface plasmon resonance (LSPR) maximum of the photocatalytic plasmonic nanoparticles

19. The method of claim 18, comprising selecting and providing a suitable light source and/or the composition of the bimetallic silver and gold nanoparticles to illuminate the surface with light with a wavelength maximum corresponding to the localized surface plasmon resonance (LSPR) maximum of the photocatalytic plasmonic nanoparticles

20. The method of claim 19, comprising selecting the wavelength maximum from
about 550 nm if the bimetallic gold and silver alloy comprises about, 25% by weight silver and about 75% by weight gold,
about 600 nm if the bimetallic gold and silver alloy comprises about, 20% by weight silver and about 80% by weight gold,
about 650 nm if the bimetallic gold and silver alloy comprises about 15% by weight silver and about 85% by weight gold,
about 700 nm if the bimetallic gold and silver alloy comprises about 10% by weight silver and about 90% by weight gold, and
about 750 nm if the bimetallic gold and silver alloy comprises about 5% by weight silver and about 95% by weight gold.
